(19) United States
(12) Patent Application Publication
(10) Pub. No.: US 2019/0072672 A1
(43) Pub. Date: Mar. 7, 2019

(54) APPLICATIONS OF OPTOELECTRONIC OSCILLATOR (OEO) INCLUDING LIGHT DETECTION AND RANGING (LIDAR) AND OPTICAL FREQUENCY DOMAIN REFLECTOMETER (OFDR) SYSTEMS

(71) Applicant: Xiaotian Steve Yao, Huntington Beach, CA (US)

(72) Inventor: Xiaotian Steve Yao, Huntington Beach, CA (US)

(21) Appl. No.: 16/121,572

(22) Filed: Sep. 4, 2018

Related U.S. Application Data
(60) Provisional application No. 62/553,789, filed on Sep. 1, 2017.

(51) Int. Cl. G01S 17/02; G01S 7/481

(52) U.S. Cl. CPC G01S 17/026; G01S 7/4814; G01S 7/4817

(57) ABSTRACT

Techniques, devices or systems based on optoelectronic oscillators (OEOs) to provide operations of optical sensing and ranging and other optical sensing operations including detecting objects based on light detection and ranging (LiDAR) based on either continuous wave or pulsed optical probe light from OEOs.

### PRIORITY CLAIM AND CROSS-REFERENCE TO RELATED APPLICATION

This application claims the benefit of U.S. Provisional Patent Application Ser. No. 62/553,789, filed Sep. 1, 2017, which is incorporated by reference herein in its entirety.

### TECHNICAL FIELD

The technology disclosed in this patent document relates to devices or systems based on optoelectronic oscillators.

### BACKGROUND

Opto-electronic oscillators (OEOs) are special oscillators that generate RF or microwave oscillations carried by modulated light. Initially developed by NASA Jet Propulsion Laboratory and California Institute of Technology. OEOs are hybrid oscillators with unique characteristics. Such an OEO includes an electrically controllable optical modulator and at least one active opto-electronic feedback loop that comprises an optical part and an electrical part interconnected by a photodetector. The opto-electronic feedback loop receives the modulated optical output from the modulator and converted the modulated optical output into an electrical signal to control the modulator. The loop produces a desired delay and feeds the electrical signal in phase to the modulator to generate and sustain both optical modulation and electrical oscillation at a radio frequency or microwave frequency when the total loop gain of the active opto-electronic loop and any other additional feedback loops exceeds the total loss. See, e.g., U.S. Pat. No. 5,723,856 to Yao and Maleki and U.S. Pat. No. 5,777,778 to Yao, which are incorporated by reference as part of the disclosure of this patent document.

OEOs use optical modulation to produce oscillations in frequency spectral ranges that are outside the optical spectrum, such as in RF and microwave frequencies. The generated oscillating signals are tunable in frequencies and can have narrow spectral linewidths and low phase noise in comparison with the signals produced by other RF and microwaves oscillators. OEOs can be used as voltage-controlled RF oscillators with phase-locked loops can be used for, among others, clock recovery, carrier recovery, signal modulation and demodulation, and frequency synthesizing.

### SUMMARY

The technology disclosed in this patent document can be implemented to construct devices or systems based on optoelectronic oscillators (OEOs) and to provide operations of optical sensing and ranging based on OEO operations.

In one aspect, the disclosed technology can be implemented to provide a method for detecting objects based on light detection and ranging (LiDAR). This method includes operating an opto-electronic oscillator to produce modulated optical output that is modulated to carry an electrical radio frequency (RF) or microwave oscillation signal at a radio frequency or microwave frequency for LiDAR sensing; controlling the opto-electronic oscillator to tune the radio frequency or microwave frequency of the electrical radio frequency (RF) or microwave oscillation signal over time; scanning the modulated optical output from the opto-electronic oscillator as probe light for illuminating a region of interest to detect objects in the region;| operating an optical detector to receive returned probe light from the region to produce a detector electrical signal; and mixing the electrical signal from the opto-electronic feedback loop of the opto-electronic oscillator and the detector electrical signal from the optical detector to produce beat signals representing position information of objects present in the region illuminated by the scanning probe light based on the tuning in the radio frequency or microwave frequency of the electrical oscillation signal from the opto-electronic oscillator.

In implementing the method, the opto-electronic oscillator can be tuned to change the radio frequency or microwave frequency carried by the modulated optical output in performing LiDAR sensing without using a tunable laser in the opto-electronic oscillator; the beat signals representing position information of objects present in the region illuminated by the scanning probe light can be used to generate a 2-dimensional or 3-dimensional map of the region containing detected objects. In addition, the method can be implemented by using a clock signal in the electrical signal from the opto-electronic feedback loop to determine relative delays in the detector electrical signal from the optical detector for the returned probe light from the region to determine the positions of the objects present in the region.

In another aspect, the disclosed technology can be implemented to provide a light detection and ranging (LiDAR) system. This LiDAR system includes an opto-electronic oscillator, an optical scanner, an optical detector and a signal mixer. The opto-electronic oscillator includes an electrically controllable optical modulator, an opto-electronic feedback loop that comprises an optical part and an electrical part interconnected by a photodetector to receive a modulated optical output from the optical modulator and to convert the modulated optical output into an electrical signal to control the optical modulator so that the modulated optical output is modulated to carry an electrical oscillation signal at a radio frequency (RF) or microwave frequency. The opto-electronic feedback loop is structured to feed the electrical signal in phase to the optical modulator to generate and sustain both optical modulation and electrical oscillation at the radio frequency or microwave frequency, and the opto-electronic oscillator is tunable to change the radio frequency or microwave frequency of the electrical oscillation signal. The optical scanner is coupled to receive a portion of the modulated optical output from the optical modulator of the opto-electronic oscillator as probe light for illuminating a target. The optical detector is located to receive returned probe light from the target to produce a detector electrical signal. The signal mixer is coupled to the opto-electronic oscillator to receive the electrical signal from the electrical part of the opto-electronic feedback loop of the opto-electronic oscillator and coupled to receive the detector electrical signal from the optical detector, the signal mixer operable to mix the electrical signal and the detector electrical signal to produce beat signals representing position information of the target based on a change in the radio frequency or microwave frequency of the electrical oscillation signal from the opto-electronic oscillator.

In another aspect, the disclosed technology can be implemented to provide a light detection and ranging (LiDAR) system that includes an opto-electronic oscillator that includes (1) a laser cavity that includes an electrically controllable optical modulator to cause mode locking in the laser cavity to produce laser pulses, and (2) an opto-electronic feedback loop that comprises an optical part and an electrical part interconnected by a photodetector to receive a modulated optical output from the optical modulator in the laser cavity and to convert the modulated optical output into an electrical signal to control the optical modulator for mode locking, wherein the opto-electronic feedback loop is structured to feed the electrical signal in phase to the optical modulator to generate and sustain both laser operation in the laser cavity and electrical oscillation at the radio frequency or microwave frequency in the opto-electronic feedback loop. This system includes an optical scanner coupled to receive a portion of the modulated optical output from the optical modulator of the opto-electronic oscillator as probe light for illuminating a target;| an optical detector located to receive returned probe light from the target to produce a detector electrical signal; and a processing circuit coupled to receive the electrical signal from the electrical part of the opto-electronic feedback loop of the opto-electronic oscillator and coupled to receive the detector electrical signal from the optical detector and to process the received signals to determine position information of the target based on time delays in receiving the laser pulses in the returned probe light.

In yet another aspect, the disclosed technology can be implemented to provide a method for detecting objects based on light detection and ranging (LiDAR) to include operating an opto-electronic oscillator to produce modulated optical output that is modulated by an optical modulator to carry an electrical radio frequency (RF) or microwave oscillation signal at a radio frequency or microwave frequency for LiDAR sensing; operating a laser cavity, which includes one or more optical gain media inside the laser cavity and the optical modulator inside the laser cavity, to modulate light inside the laser cavity to achieve mode locking to produce laser pulses; scanning the modulated optical output from the opto-electronic oscillator as probe light for illuminating a region of interest to detect objects in the region;| operating an optical detector to receive returned probe light from the region to produce a detector electrical signal; and processing the electrical signal from the opto-electronic oscillator and the detector electrical signal from the optical detector to determine relative delays of the laser pulses in the returned probe light from the region to determine the positions of the objects present in the region.

In yet another aspect, the disclosed technology can be implemented to provide an optical frequency domain reflectometer (OFDAR) system to include an opto-electronic oscillator that includes a laser, an electrically controllable optical modulator connecting to the laser, an opto-electronic feedback loop that comprises an optical part and an electrical part interconnected by a photodetector to receive a modulated optical output from the optical modulator and to convert the modulated optical output into an electrical signal to control the optical modulator so that the modulated optical output is modulated to carry an electrical oscillation signal at a radio frequency (RF) or microwave frequency. The opto-electronic feedback loop is structured to feed the electrical signal in phase to the optical modulator to generate and sustain both optical modulation and electrical oscillation at the radio frequency or microwave frequency, and the opto-electronic oscillator is tunable to change the radio frequency or microwave frequency of the electrical oscillation signal. This system also includes a length of optical fiber coupled to receive a portion of the modulated optical output from the optical modulator of the opto-electronic oscillator as probe light;| an optical detector located to receive returned probe light from the fiber to produce a detector electrical signal; and a signal mixer coupled to the opto-electronic oscillator to receive the electrical signal from the electrical part of the opto-electronic feedback loop of the opto-electronic oscillator and coupled to receive the detector electrical signal from the optical detector, the signal mixer operable to mix the electrical signal and the detector electrical signal to produce beat signals representing position information of reflections inside the optical fiber based on a change in the radio frequency or microwave frequency of the electrical oscillation signal from the opto-electronic oscillator.

The above and other aspects of the disclosed technology and their implementations and applications are described in greater detail in the drawings, the description and the claims.

### BRIEF DESCRIPTION OF DRAWINGS

FIG. 1 shows an example of an OEO based a FMCW (Frequency Modulated Continuous Wave) LiDAR (Light Detection and Ranging) system in which the tunable OEO simultaneously generates a low phase noise RF signal with linearly swept frequency and a modulated optical signal. The optical beam is directed to a 1D or 2D beam scanner and sent out to open space for the detection of obstacles. The reflections from different obstacles are then directed to the photodetector via the circulator to convert them into RF signals before being amplified by the RF amplifier. The reflected signals are then mixed with the RF output of the OEO to generate low frequency beat signals, which are then pass through the low pass filter and being analyzed by a RF spectrum analyzer, or a digitizer with Fast Fourier Transform (FFT) processing. The beat frequencies represent the locations of the obstacles.

FIG. 2 shows an example of a processed ranging map in which FIG. 2a shows a series of data showing the reflections of signals as a function distance at different beam angles, and FIG. 2b shows the corresponding obstacle map in a 2D spherical coordinate. A map can be obtained in a 3D spherical coordinate based on this technique.

FIG. 3 shows an example of an OEO-based optical frequency domain reflectometer (OFDR) is a simplified version of OEO based LiDAR in which no optical beam scan is required. Reflections inside the fiber or in free space can be detected and their locations can be identified.

FIG. 4 shows an example of a tunable opto-electronic oscillator in which the laser can be of a DFB type and the modulator can be of Lithium Niobate, electro-absorption, of semi-conductor MZ modulator. The tunable filter includes YIG filter and the active filter described in FIG. 7.

FIG. 5 shows an example of a hybrid integrated OEO module. The laser and modulator can be integrated together on the same semi-conductor chip, such as the case for the DFB and electro-absorption modulator. The DFB laser/modulator, together with photodetector. RF amplifier, and the tunable filter can be integrated on a same substrate, with only the fiber coil is outside of the substrate. The OEO module can be based on silicon photonics integrated circuit in which a laser, an optical modulator, a photodetector, and an optical coupler are integrated on a silicon substrate. Further integration may also include the RF amplifier and filter.

FIG. 6 shows an example of a tunable opto-electronic oscillator on a chip, in which the laser, modulator, waveguide and the photodetector are all made with InGaAs semiconductor. A high Q microresonator, such as microsphere or micro-disk, is used as the energy storage component. The resonator may be a microsphere resonator coupled to the optical waveguides via evanescent coupling.

FIG. 7 shows an example of fast tunable active RF filter (TF). The gain of the amplifier is properly chosen to be slightly below the oscillation threshold to get a very high Q. The filter can be implemented on a ceramic or another type RF substrate with hybrid technology for compactness.

FIG. 8 shows an example of a coupled opto-electrical oscillator (COEO) based LiDAR. The COEO simultaneously generates a low phase noise RF clock signal in the RF domain and a pulsed optical signal in the optical domain. The pulsed optical beam is scanned and send out in free-space to detect obstacles. Both The reflected signals from the obstacles are detected by a photodetector and amplified. The relative delay between the RF clock and the reflected signal is obtained by the electronics circuit to determine the positions of the obstacles.

FIG. 9 shows an example of coupled optoelectronic oscillator (COEO) on a chip. The microsphere is an example micro-resonator. Other types of micro-resonators can also be used. The oscillation frequency can be tuned by tuning the resonant frequency of the micro-resonator by either applying a voltage or by changing its temperature. The COEO chip can be made with InGaAs technology.

### DETAILED DESCRIPTION

The technology disclosed in this patent document can be implemented to construct devices or systems based on applications of optoelectronic oscillators (OEOs) to benefit from one or more unique properties or characteristics of OEOs, including low phase noise, spectral purity or narrow spectral width, immunity to EM interference, sharp falloff in the frequency domain, availability of optical processing and optical transmission, among others.

A variety of OEOs can be constructed. U.S. Pat. Nos. 5,723,856 and 5,777,778 provide examples of single-loop OEOs and multi-loop OEOs. Another type of OEOs is coupled opto-electronic oscillators (“COECs”) described in U.S. Pat. No. 5,929,430 where a COEO directly couples a laser oscillation in an optical feedback loop to an electrical oscillation in an opto-electronic feedback loop. OEOs may be constructed by including optical resonators in the OEO loops as disclosed in U.S. Pat. No. 6,567,436 in which various forms of optical resonators may be used including optical whispering gallery mode resonators (e.g., U.S. Pat. Nos. 6,389,197 and 6,795,481) and other compact resonators such as integrated ring resonators for forming integrated opto-electronic oscillators having optical resonators (e.g., U.S. Pat. No. 6,873,631). OEOs can also be implemented by having at least one active opto-electronic feedback loop that generates an electrical modulation signal based on the stimulated Brillouin scattering where a Brillouin optical medium is included in the feedback loop to provide a natural narrow linewidth of the Brillouin scattering to select a single oscillating mode (e.g., U.S. Pat. Nos. 5,917,179, 6,417,957 and 6,476,959). OEOs can be used to suppress phase noise in RF or microwave oscillation signals (e.g., U.S. Pat. No. 6,580,532). Each of the above mentioned U.S. patents is incorporated by reference and is attached here as part of the disclosure of this patent document. An OEO based on the above and other implementations can be made tunable to allow for tuning one or more components inside the OEO to change the frequency of the electrical modulation signal (RF or microwave frequency) carried by the optical signal at an optical carrier frequency. As illustrated by examples of OEO-based LiDAR designs in this document, this tuning in the RF frequency can be used to transform a time delay due to travel of light over a distance into a frequency shift of the RF signal carried by the reflected light so that measuring such frequency shifts of the RF signal carried by the reflected light from different locations can be used to measure different distances for various objects illuminated by the OEO optical output in detecting the objects.

Light detection and ranging (LiDAR) systems generate probe light (e.g., laser light) for illuminating a target and detected returned probe light from the target to measure a distance to the target. Differences in laser return times and wavelengths can then be used to make digital 3D-representations of the target. LiDAR can be used in a wide range of applications including autonomous vehicles for obstacle detection and avoidance to navigate safely through environments, using rotating laser beams. Such LiDARs can be used to provide the necessary data for robot software to determine where potential obstacles exist in the environment and where the robot is in relation to those potential obstacles.

Comparing with many Radar systems which use RF waves rather than laser light in LiDAR, LiDAR tends to be more accurate in determining the location of the obstacles because the laser beam does not spread like a RF beam. Many LiDARs are designed to send out a pulsed laser beam and measure reflected pulsed light back to the sensor. The distance of an object can be determined by measuring the relative delay between the outgoing pulse and the returned pulse. The shorter the pulses, the more accurate the location determination may become.

As a specific example for LiDAR applications, automobiles such as autonomous vehicles may be equipped with Radar and LiDAR devices for detecting obstacles, pedestrians, and other vehicles. LiDAR does not require RF spectrum allocation for Radar. and avoiding interference with other RF signals. LiDAR provides better directivity and spatial resolution, and longer range.

For self-driving automobiles, it is desirable to keep the cost of the LiDAR sufficiently low in order to be commercially feasible for the car manufacturers. For a pulsed LiDAR, it can be expensive to generate very short optical pulses, on the order of nanoseconds or less. In addition, the electronics for detecting such short pulses may also be expensive, further exacerbating the overall costs of LiDAR sensors. It is therefore desirable to develop a low cost alternative LiDAR sensors from various existing LiDAR designs.

One type of LiDAR systems is a chirped or FMCW (Frequency Modulated Continuous Wave) LiDAR in which the laser's frequency is linearly swept or tuned. The reflected light from an obstacle at a distance is therefore at a different frequency from that of a reference beam in such a FMCW LiDAR system. The beat frequencies of the two beams in a photodetector therefore carry the distance information of the obstacles, which can be extracted by taking the fast Fourier transform (FFT) of the beat signal. Such a chirped LiDAR system is similar to an optical frequency domain reflectometer (OFDR) for optical fiber measurements as illustrated by OFDR examples in U.S. Pat. Nos. 9,719,883 and 9,632,006 (which are incorporated by reference as part of the disclosure of this patent document), and the laser source should emit laser light with much longer coherence length than the intended detection range of the LiDAR. Unfortunately, such a tunable laser tends to be expensive.

The disclosed technology in this patent document can be used to provide a LiDAR system based on an Opto-electronic Oscillator (OEO). In various implementations of the disclosed technology, a LiDAR system does not require the frequency tunability of the laser nor its long coherence length for ranging, often found in other FMCW LiDAR systems. Instead, the OEO in such a LiDAR system produces modulated laser light that carries a RF or microwave signal for the LiDAR ranging operations.

The disclosed technology can be implemented to construct a LiDAR system that includes an opto-electronic oscillator that includes an electrically controllable optical modulator, an opto-electronic feedback loop that comprises an optical part and an electrical part interconnected by a photodetector to receive a modulated optical output from the optical modulator and to convert the modulated optical output into an electrical signal to control the optical modulator so that the modulated optical output is modulated to carry an electrical RF or microwave oscillation signal at a radio frequency or microwave frequency. The opto-electronic feedback loop is structured to feed the electrical signal in phase to the optical modulator to generate and sustain both optical modulation and electrical oscillation at the radio frequency or microwave frequency. The LiDAR system includes an optical scanner coupled to receive a portion of the modulated optical output from the optical modulator of the opto-electronic oscillator as probe light for illuminating a target; an optical detector located to receive returned probe light from the target to produce a detector electrical signal; and a signal mixer coupled to the opto-electronic oscillator to receive the electrical signal from the electrical part of the opto-electronic feedback loop of the opto-electronic oscillator and coupled to receive the detector electrical signal from the optical detector, the signal mixer operable to mix the electrical signal and the detector electrical signal to produce beat signals representing position information of the target.

Such an OEO-based LiDAR system can may be implemented in various configurations and by using different types of OEOs.

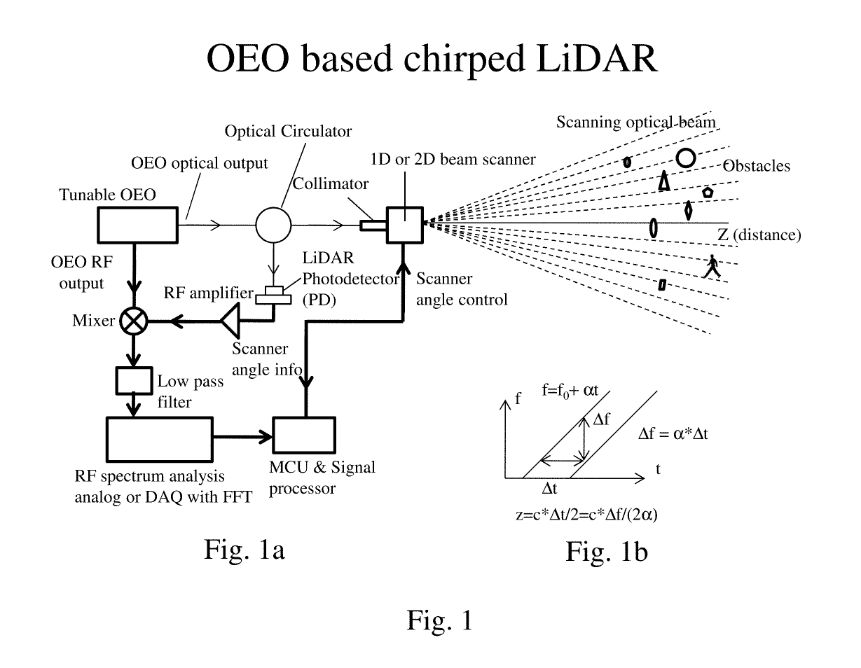

The disclosed technology may be implemented to utilize OEOs that produce a continuous wave (CW) optical output that is at an optical carrier frequency or wavelength and is modulated to carry the RF or microwave oscillation signal. The optical detection at such a CW OEO-based LiDAR detects the reflection of the CW optical output and measures phase shifts or changes in the RF or microwave signal frequency in the RF or microwave signal carried by the reflected CW optical carrier to perform the LiDAR measurements. See examples in FIGS. 1 through 6 in this patent document.

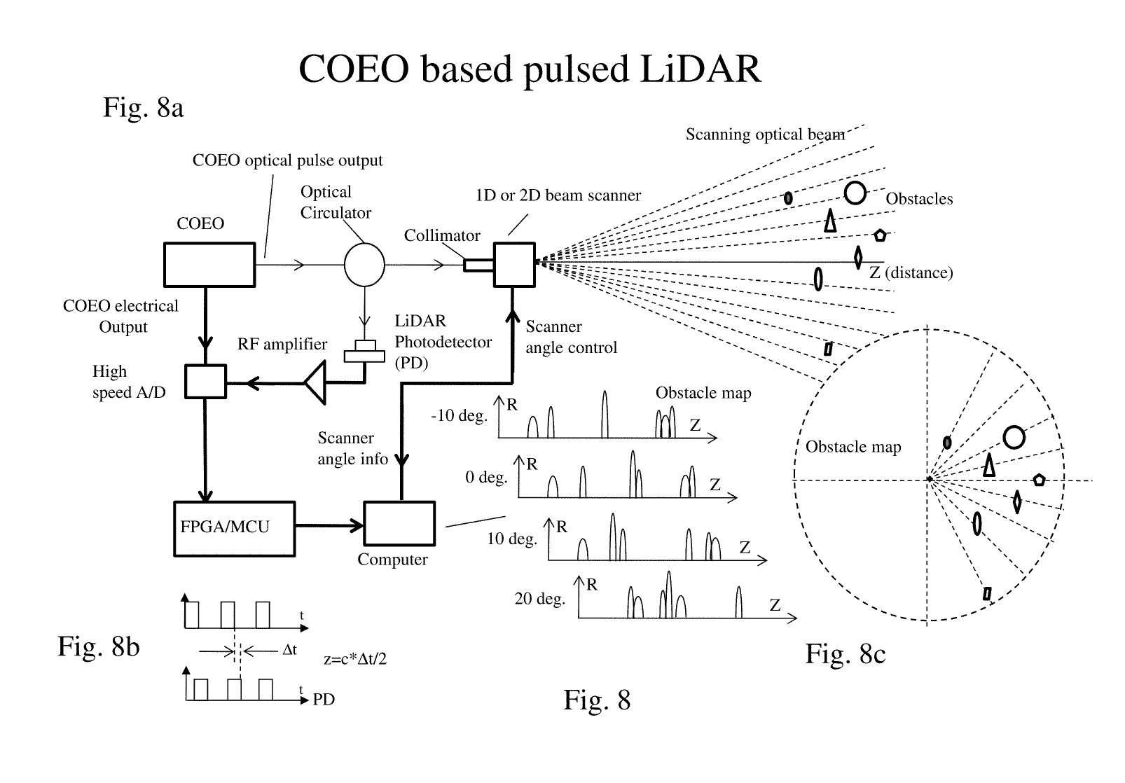

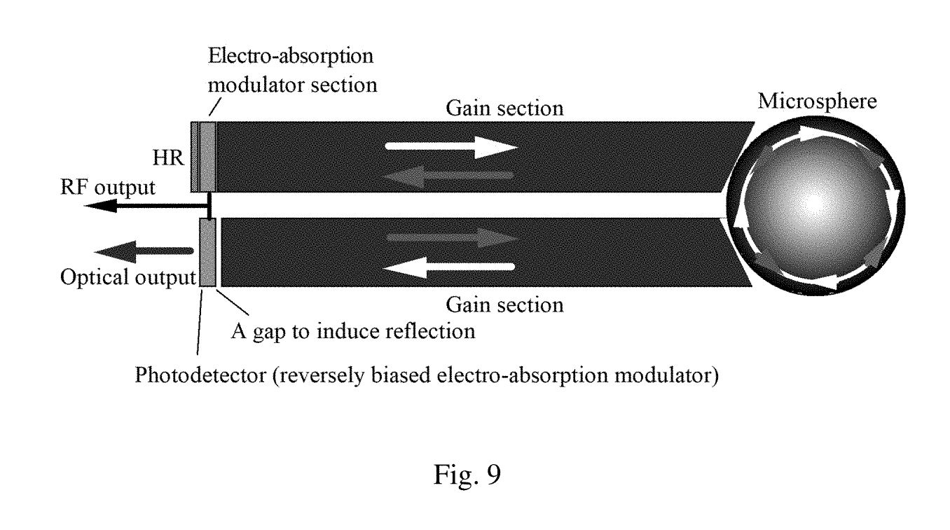

Alternatively, the disclosed technology may be implemented to utilize OEOs that produce a pulsed optical output with a train of periodic laser pulses spectrally centered at an optical carrier frequency or wavelength and modulated to carry the RF or microwave oscillation signal. The optical detection at such a pulsed OEO-based LiDAR detects the reflection of the reflected laser pulses and measures the time delays in the reflected laser pulses to perform the LiDAR measurements. See examples in FIGS. 8 and 9 in this patent document.

FIG. 1 shows an example of an OEO-based FMCW LiDAR system that uses CW light from the OEO as the probe light for the LiDAR sensing and the phase shifts in the RF or microwave signal carried by the reflected CW probe light from targets to determine the distances and positions of the illuminated targets. FIG. 1 includes FIGS. 1a and 1b where FIG. 1a shows the hardware of the system, and FIG. 1b shows an example of changing the RF frequency of the OEO by a linear sweep.

The example in FIG. 1 is one particular implementation of a LiDAR system that includes an opto-electronic oscillator, an optical scanner, an optical detector and a processing circuit. The opto-electronic oscillator includes an electrically controllable optical modulator, an opto-electronic feedback loop that comprises an optical part and an electrical part interconnected by a photodetector to receive a modulated optical output from the optical modulator and to convert the modulated optical output into an electrical signal to control the optical modulator so that the modulated optical output is modulated to carry an electrical oscillation signal at a radio frequency (RF) or microwave frequency. The opto-electronic feedback loop is structured to feed the electrical signal in phase to the optical modulator to generate and sustain both optical modulation and electrical oscillation at the radio frequency or microwave frequency, and the opto-electronic oscillator is tunable to change the radio frequency or microwave frequency of the electrical oscillation signal. The optical scanner is coupled to receive a portion of the modulated optical output from the optical modulator of the opto-electronic oscillator as probe light for illuminating a target. The optical detector is located to receive returned probe light from the target to produce a detector electrical signal. The processing circuit is coupled to the opto-electronic oscillator to receive the electrical signal from the electrical part of the opto-electronic feedback loop of the opto-electronic oscillator and coupled to receive the detector electrical signal from the optical detector, to process the received signals to determine position information of the target.

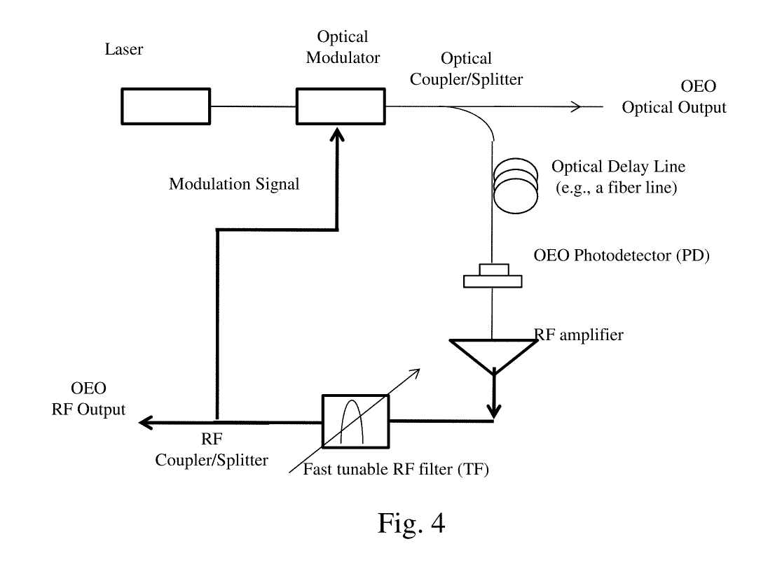

Specifically, as shown in FIG. 1a, a tunable OEO is provided to simultaneously generate a low phase noise RF signal with a linearly swept frequency by tuning the OEO and a CW modulated optical signal that carries the low phase noise RF signal as the OEO optical output at an optical carrier frequency. As described above and referring to OEO examples in FIGS. 4-6, the tunable OEO includes an OEO feedback loop having an electrical part that carries the low phase noise RF signal with a tunable RF frequency (e.g., being swept linearly or in other manner), an optical part that carries the CW OEO optical output at the optical carrier frequency, and an OEO optical detector as one interface between the optical part and the electrical part. The OEO-based LiDAR example in FIG. 1 shows that a portion of the low phase noise RF signal in the tunable OEO is coupled out as an OEO RF output to a signal mixer while the remaining low phase noise RF signal stays within the tunable OEO to sustain the OEO oscillation within the OEO feedback loop in both optical and RF domains via RF (electrical) to optical conversion at an optical modulator inside the OEO and the optical to RF (electrical) conversion at the OEO optical detector.

The OEO-based LiDAR example in FIG. 1a uses an optical circulator or another optical routing device to (1) couple the OEO optical output for scanning and sensing and (2) receive and direct optical reflection of the OEO optical output for LiDAR detection and processing. Specifically, the optical circulator directs the OEO optical output to a beam scanner (e.g., a 1D or 2D beam scanner) which scans the optical beam out to open space or a target region of interest for detecting or sensing obstacles or objects. The optical reflections from different obstacles or objects are received and directed to a designed LiDAR photodetector via the optical circulator. The LiDAR photodetector converts the optical reflections into RF signals before being amplified by the RF amplifier for further processing. The output of the RF amplifier representing the optical reflected signals is mixed with the RF output of the OEO to generate low frequency beat signals, which are then pass through the low pass filter and being analyzed by a RF spectrum analyzer, or a digitizer with Fast Fourier Transform (FFT) processing. The beat frequencies represent the locations of the obstacles.

In operation, the tunable OEO is operated to tune or change the OEO's output frequency by linearly sweeping the RF or microwave frequency carried by the OEO's optical output at an optical carrier frequency. See FIG. 1a. The OEO's optical output is directed via the optical circulator to the 1-dimensional or 2-dimensional beam scanner which scans the OEO's optical output in a target region for optical sensing. The OEO's optical output is reflected back by different objects in the scanning path of the OEO's optical output and the optical reflection is received and is directed by the optical circulator and the frequency of the reflected signal with a time delay Δt is different from the OEO RF output by an amount of Δf. Assuming α is the rate at which the RF frequency is swept or tuned with respect to time, the change in the RF frequency in the RF signal from the tunable OEO is

Δf=α*Δt

This frequency difference Δf between the reference signal directly from OEO's RF output port and the reflected signal from an object at distance z can be detected by the mixer. The distance of the object at z that causes this frequency difference can be obtained by z=c*Δt/2=c*Δf/(2α). See FIG. 1b. Therefore, by detecting the frequency difference between the reference and the reflected signal, the distance of the object can be determined. Mathematically, by taking the FFT of the signal from the mixer, the frequencies of the reflected signals from different objects can be directly converted to distances of the corresponding objects. This mechanism enables LiDAR sensing of objects at different distances.

The OEO-based FMCW LiDAR system shown in FIG. 1 relies on a CW tunable OEO with frequency tunability to generate a highly spectrally pure RF or microwave signal and a modulated optical signal that carries the RF or microwave signal with the same frequency. The tunable OEO can be designed and operated to generate a linear frequency ramp, for example, from 5 GHz to 15 GHz in some applications, and the modulated optical signal is then sent out to open space for obstacle detection. The reflected optical signal from an obstacle is then detected by a photodetector, amplified by an RF amplifier, and finally mixed with the microwave signal directly from the OEO. An optical amplifier, such as an Erbium doped fiber amplifier (EDFA) and or a semiconductor optical amplifier (SOA) before the circulator or the photodetector, can be used to boost either the optical signal sending to the targets or the returned signal from the targets. The beat frequency between the OEO signal and the reflected signal is directly proportional to a range of the obstacle. Therefore, by taking FFT of the beat signal, the positions of all the obstacles can be determined. Due to the low phase noise and high spectral purity of the OEO, the ranging distance can be greatly increased.

In certain implementations of the design in FIG. 1, an optically dispersive component is included in the opto-electronic loop and the laser is tuned in frequency to tune the radio frequency or microwave frequency of the electrical oscillation signal from the opto-electronic oscillator.

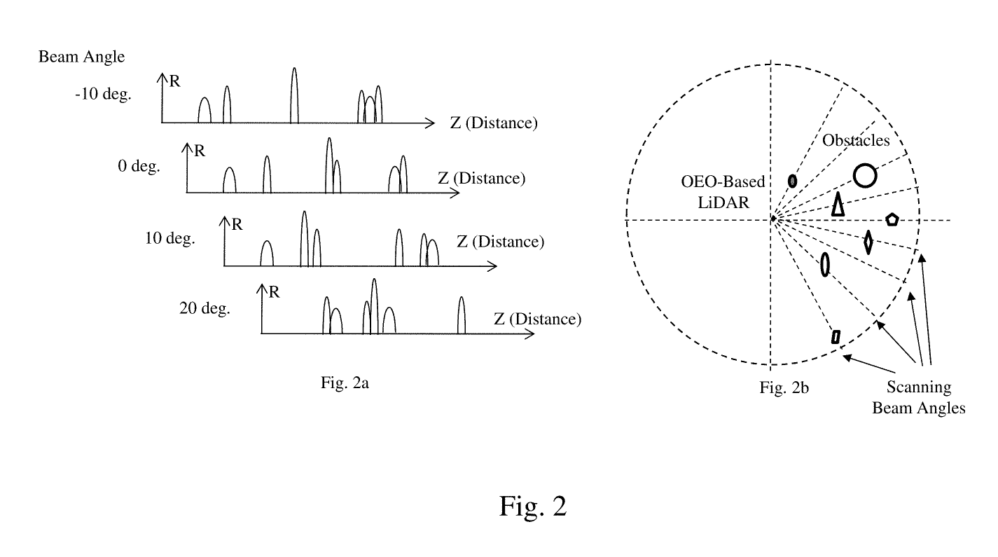

FIG. 2 illustrates examples of the processed ranging map for the OEO-based FMCW LiDAR system shown in FIG. 1. FIG. 2(a) shows a series of data representing reflections of signals as a function of the distance at different beam angles caused by scanning of the beam scanner in FIG. 1 where the vertical axis represents the reflected signal strengths and the horizontal axis represents the distance. FIG. 2(b) shows an example of an obstacle map in a 2D spherical coordinate. Similar maps can be obtained in a 3D spherical coordinate.

In comparison with other FMCW LiDAR systems, the signal processing in the OEO-based FMCW LiDAR system shown in FIG. 1 is mostly in the RF domain so that the requirements on the phase noise or coherence length is greatly reduced. A telecom grade DFB laser of a fixed wavelength in the OEO system is sufficient without using a tunable laser. Different from other FMCW RADAR systems, the OEO-based FMCW LiDAR system in FIG. 1 only sends out modulated laser probe light for sensing and thus does not send out RF signals in space because an RF signal is embedded in the modulated laser probe light. Therefore, the OEO-based FMCW LiDAR system in FIG. 1 does not involve RF spectrum license issues. This aspect of the disclosed technology based on OEOs can greatly reduce related business costs. The ranging beam of the OEO-based FMCW LiDAR system in FIG. 1, is in the optical domain and has advantages offered by a LiDAR, such as high spatial and angular accuracy and resolution, which are desirable to the autonomous driving vehicles.

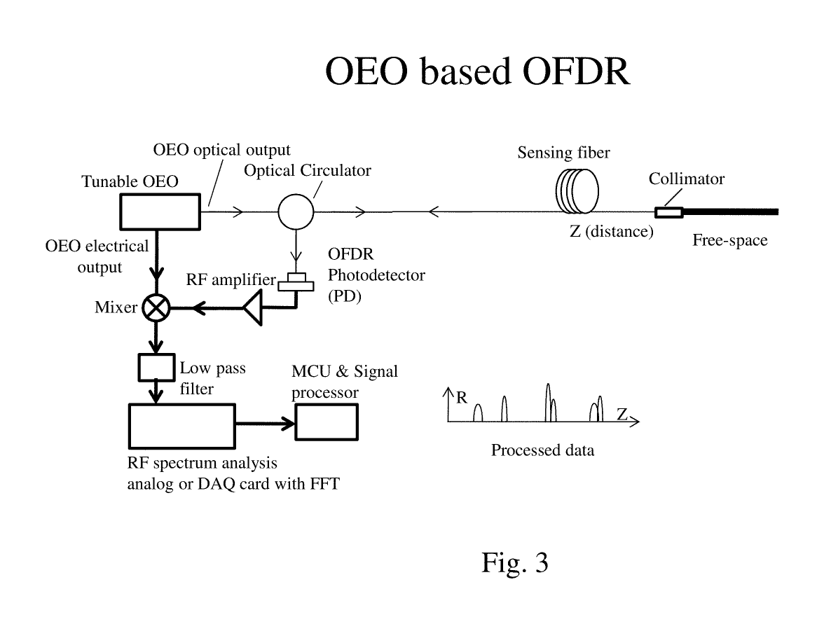

FIG. 3 illustrates an example of an OEO based Optical Frequency Domain Reflectometry (OFDR), which may be viewed as a simplified OEO based LiDAR without optical beam scanning. Reflections inside the fiber or in free space can be detected and their locations can be identified. See examples for polarization-based OFDR devices and their operations in U.S. Pat. Nos. 9,719,883 and 9,632,006 which are incorporated by reference as part of the disclosure of this patent document. For example, a polarization-sensitive optical frequency domain reflectometer (OFDR) device can be constructed for measuring a distributed fiber bend or stress profile with respect to the distance or location of each fiber end location based on optical polarization sensing. In one implementation, such an OFDR device include a light source that produces probe light that is at least partially coherent; an optical unit that includes different optical ports positioned relative to the probe light from the light source and relatively to a fiber link under test, couples the probe light from the light source into the fiber link under test in an input state of polarization (I-SOP), and receives reflected probe light from the fiber link under test in an output state of polarization (O-SOP) to produce first and second optical signals in two different optical polarizations from the reflected probe light; an optical coupler that couples a portion of the probe light as an optical local oscillator light; an optical detection unit that includes different receiving ports, the optical detection unit coupled to receive the optical local oscillator light and the first and second optical signals and configured to mix the optical local oscillator light with the first and second optical signals to perform coherent detection of the first and second optical signals; and a signal processor that processes information from the coherent detection of the first and second optical signals to compute a difference in measurements of an optical parameter in reflected probe light from two different locations in the fiber under test and compute a polarization-dependent property of a fiber bend or stress from the computed difference at different positions along a fiber path in the fiber link under test to provide an assessment of the fiber bend or stress in the fiber link under test. In FIG. 3, the tunable OEO is provided as the light source for the OFDR device to direct probe light produced by the OEO to the target sensing fiber and the reflected light is routed to an OFDR photodetector for conversion into an RF signal for mixing with the OEO RF output at the signal mixer.

Therefore, the disclosed technology can be implemented to provide an optical frequency domain reflectometer (OFDAR) system to include an opto-electronic oscillator that includes a laser, an electrically controllable optical modulator connecting to the laser, an opto-electronic feedback loop that comprises an optical part and an electrical part interconnected by a photodetector to receive a modulated optical output from the optical modulator and to convert the modulated optical output into an electrical signal to control the optical modulator so that the modulated optical output is modulated to carry an electrical oscillation signal at a radio frequency (RF) or microwave frequency. The opto-electronic feedback loop is structured to feed the electrical signal in phase to the optical modulator to generate and sustain both optical modulation and electrical oscillation at the radio frequency or microwave frequency, and the opto-electronic oscillator is tunable to change the radio frequency or microwave frequency of the electrical oscillation signal. This system also includes a length of optical fiber coupled to receive a portion of the modulated optical output from the optical modulator of the opto-electronic oscillator as probe light;| an optical detector located to receive returned probe light from the fiber to produce a detector electrical signal; and a signal mixer coupled to the opto-electronic oscillator to receive the electrical signal from the electrical part of the opto-electronic feedback loop of the opto-electronic oscillator and coupled to receive the detector electrical signal from the optical detector, the signal mixer operable to mix the electrical signal and the detector electrical signal to produce beat signals representing position information of reflections inside the optical fiber based on a change in the radio frequency or microwave frequency of the electrical oscillation signal from the opto-electronic oscillator.

A CW tunable OEO can be implemented in various configurations for OEO-based on LiDAR. FIGS. 4-6 show examples of OEOs.

FIG. 4 shows an example of a tunable opto-electronic oscillator where a laser produces laser light to an optical modulator which modulates the received laser light in response to an input modulation signal. The laser can be of a distributed feedback (DFB) type laser and the optical modulator can be implemented in various modulator configurations, including, e.g., a Lithium niobate optical modulator, an electro-absorption optical modulator, a semiconductor Mach-Mach-Zehnder optical modulator. An optical splitter or coupler is used to split a portion of the modulated optical output from the optical modulator as an optical output of the tunable OEO while the other portion is directed into the optical loop that is coupled to the optical detector as an interface between the optical part and electrical part of the OEO loop. In the electrical part of the OEO loop that is coupled to the optical detector, a tunable RF filter is provided to filter the RF output of the optical detector. The tunable RF filter may be a fast tunable filter and, in some implementations, may include a Yttrium Iron Garnet (YIG) filter or an active RF filter described in FIG. 7. The tuning of the RF frequency in the low phase noise RF signal in the OEO in FIG. 4 can be achieved by turning the length of the optical delay line in the optical part of the OEO feedback loop with a suitable tuning mechanism, such as a fiber stretcher or other tuning devices. For another example, a RF tuning device such as a tunable RF filter in the electrical part of the OEO feedback loop in FIG. 4 can be used to tune the RF frequency. As yet another example, the RF frequency of the OEO may be used b tuning both the optical delay line and the RF part.

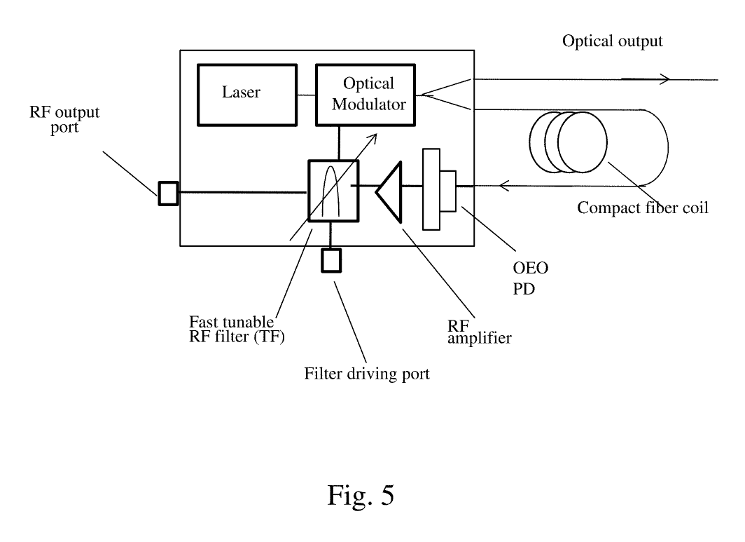

FIG. 5 shows an example of a hybrid integrated OEO module. The laser and optical modulator can be integrated together on the same semi-conductor chip, such as the case for the DFB and electro-absorption modulator. The DFB laser/modulator, together with photodetector, RF amplifier, and the tunable filter can be integrated on a same substrate, with only the fiber coil is outside of the substrate. The OEO module can be based on silicon photonics integrated circuit in which a laser, an optical modulator, a photodetector and an optical coupler are integrated on a substrate such as a silicon substrate. This OEO design be used to provide further integration by integrating various circuits, such as an RF amplifier and an RF filter onto the substrate. The tuning of the RF frequency in the low phase noise RF signal in the OEO in FIG. 5 can be achieved by turning either or both of the length of the optical delay line in the optical part of the OEO feedback loop with a suitable tuning mechanism, such as a fiber stretcher or other tuning devices, or operating the tunable RF filter or other RF tuning device in the electrical part of the OEO feedback loop.

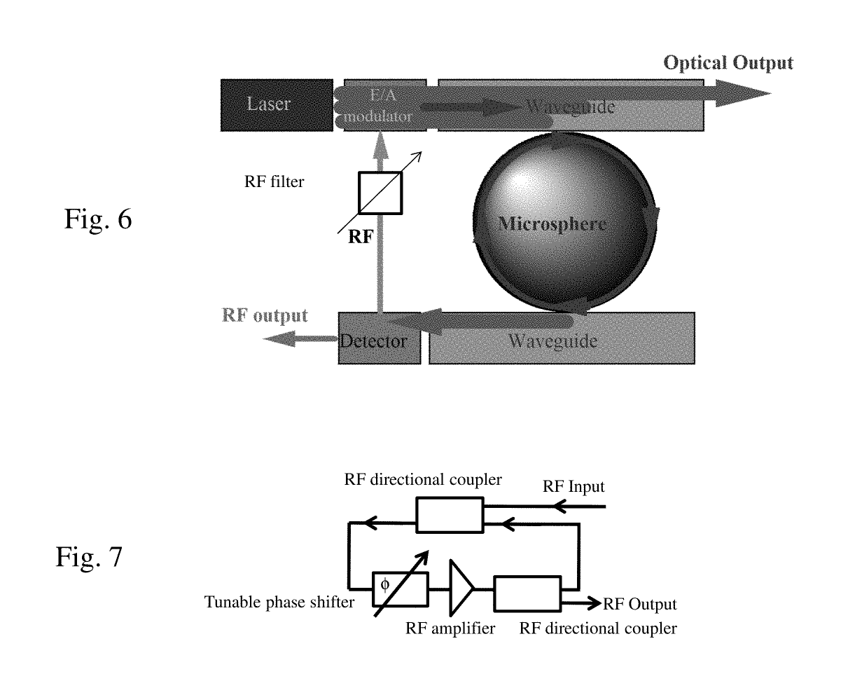

FIG. 6 shows an example of a tunable opto-electronic oscillator on a chip, in which the laser, modulator, waveguide and the photodetector are all made with InGaAs or another suitable semiconductor material. This example shows a specific implementation of an integrated opto-electronic oscillator that includes a substrate; a laser formed on the substrate to produce laser light; an optical modulator formed on the substrate and optically coupled to receive the laser light from the laser and the electrical signal to cause optical modulation on the received laser light in response to the electrical signal to produce modulated laser light that is present in the optical part of the opto-electronic feedback loop; optical waveguides formed on the substrate as part of the optical part of the opto-electronic feedback loop, wherein at least one of the optical waveguides is optically coupled to receive the modulated laser light from the optical modulator; an optical resonator formed on the substrate and optically coupled to the optical waveguides to receive the modulated laser light as part of the optical part of the opto-electronic feedback loop; a photodetector formed on the substrate and optically coupled to receive the modulated laser light from the optical part of the opto-electronic feedback loop to produce an electrical detector signal; and a circuit coupled to receive the electrical detector signal from the photodetector and to generate the electrical signal based on the electrical detector signal, the circuit further coupled to the optical modulator to apply the electrical signal to the optical modulator as part of the electrical part of the opto-electronic feedback loop.

A high Q microresonator, such as microsphere or micro-disk, is used as the energy storage component and is coupled between two optical waveguides (e.g., via optical evanescent coupling) forming part of the optical part of the OEO loop. The tuning of this OEO may be achieved by controlling and tuning the overall optical length of the optical part of the OEO feedback loop, e.g., controlling the dimension of the microresonator by an actuator or the lengths of the optical waveguides by thermal or other control mechanism. A tunable RF device such as a tunable RF filter may be coupled in the electrical part of the OEO loop to provide the desired tuning. The tuning via optical tuning or RF tuning is to change the radio frequency or microwave frequency of the electrical oscillation signal of the OEO loop that is modulated onto and is carried by the CW optical signal as the optical output of the OEO device for the LiDAR operation.

FIG. 7 is an example of a fast tunable active RF filter (TF) that may be used for implementing the OEO devices in FIG. 5 and FIG. 6. In some implementations, the gain of the amplifier may be properly chosen to be slightly below the oscillation threshold. The filter can be implemented on a ceramic or another type RF substrate with hybrid technology for compactness.

The above OEO examples and associated OEO-LiDAR examples use modulated CW optical light from CW OEOs for LiDAR sensing and operations based on the difference in phaser or frequency of the transmitted and received RF signals carried by the CW probe light. Coupled OEOs are special OEOs that produce laser pulses with a specific period in the time domain due to the unique optical mode locking operation in COEOs. Accordingly, the disclosed technology may be implemented to utilize the reflection of a train of periodic laser pulses from targets to measure the time delays in the reflected laser pulses relative to the timing of transmission of such laser pulses out of the OEO-LiDAR to determine the distances and positions of the targets.

FIG. 8 illustrates an example of a coupled opto-electrical oscillator (COEO) based LiDAR based on measuring the differences in time of the transmitted and received laser pulses produced by the COEO. FIG. 8 includes FIG. 8a showing the system layout of the COEO-based LiDAR, FIG. 8b showing timing of the transmitted COEO laser pulses and received laser pulses reflected from targets, and FIG. 8c showing different received pulses at different scanning angles of the region under sensing by the COEO-based LiDAR.

The COEO directly couples a laser oscillation of an optical feedback system to an electrical oscillation of an opto-electronic feedback system. The laser oscillation and the electrical oscillation are correlated with each other so that both the modes and stability of one oscillation are coupled with another oscillation. In implementations, two mutually coupled oscillation systems, a laser oscillator and an opto-electronic feedback oscillator, are provided in the COEO. The laser oscillator includes an internal active optical feedback loop with a gain medium to effectuate a first loop gain greater than unity and is responsive to an electrical signal. The laser oscillator produces a coherent optical oscillation. The opto-electronic feedback oscillator is essentially an active opto-electronic feedback loop coupled to the laser oscillator and receives an optical signal from the output of the laser oscillator which is indicative of the optical oscillation.

In implementations of COEOs, the opto-electronic feedback loop can include an optical delay element for producing a delay, a photodetector responsive to intensity variation of input optical signals for converting the optical signal from the optical delay element into an electrical modulation signal and an electrical interface with the laser oscillator to feed electrical modulation signal to the gain medium which modulates the optical gain in the optical feedback loop. Furthermore, the opto-electronic feedback loop can include a second loop gain greater than unity to generate and sustain an electrical oscillation therein. In designing COEOs, a specific relation between the loop length of the optical feedback loop in the laser oscillator and the loop length of the opto-electronic feedback loop can be achieved to make both optical and electrical oscillations stable. COEOs may include other elements in the opto-electronic feedback loop, e.g., an RF amplifier, a variable electrical delay element, a bandpass RF filter, a variable RF attenuator, an RF coupler, and an optical coupler. One of the advantages is that the COEO can be self-oscillating without an external pump laser, although an external laser may be used in a COEO. Therefore, a coupled opto-electronic oscillator can be used to accomplish single-mode selection for a system having a very long opto-electronic feedback loop. In some implementations, a multimode laser can be used with an COEO to pump the electronic oscillation, and to achieve in an efficient operation and reduced manufacturing cost. Furthermore, the COEO can provide a link between the optical and the microwave oscillations, which can be further used for simultaneously generating stable optical pulses and a continuous microwave oscillating signal (e.g., sinusoidal wave). Such an COEO directly couples a laser oscillation with an electronic oscillation to simultaneously achieve a stable RF oscillation at a high frequency and ultra-short optical pulsation by mode locking with a high repetition rate and stability. This mode locking in the optical feedback of the optical loop for laser oscillation may be achieved by adjusting the relative phase delay between the optical loop and the opto-electronic loop via one or more ways, including the using a variable optical phase delay element in the optical loop, an adjustable optical delay element in the optical part of the opto-electronic loop or an adjustable electrical delay element in the electrical part of the opto-electronic loop. The relative phase delay between the two coupled loops is so adjusted that one of the RF oscillation modes in the opto-electronic loop is close to or overlaps with a mode beat frequency of the optical loop to achieve the desired mod locking in the optical loop for generating laser pulses. See U.S. Pat. No. 5,929,430.

In the example of the LiDAR in FIG. 8, the COEO simultaneously generates a low phase noise RF clock signal in the RF domain and a pulsed optical signal in the optical domain. The pulsed optical beam is scanned and sent out as a train of periodic laser pulses in free-space to detect obstacles by detecting the returned laser pulses and their relative delays in time. The reflected signals from the obstacles are detected by a photodetector and amplified. The relative delay between the RF clock and the reflected signal is obtained by the electronics circuit to determine the positions of the obstacles.

Referring to FIG. 8b, due to the travel time to and from a target illuminated b the scanning probe light with laser pulses from the COEO, the arrival time of each received laser pulse reflected from a target is delayed and this time delay is directly related to the corresponding distance of the object by z=c*Δt/2. Therefore, the time delay data can be used to produce distances of the targets. In addition, as shown by FIG. 8c, the scanning of the probe light at different angles can be used to determine directions of the reflected probe light from different targets to construct the position map of different targets around the LiDAR system.

FIG. 9 is an example of a coupled optoelectronic oscillator (COEO) that is integrated on a chip. The microsphere is an example of a micro-resonator. Other types of micro-resonators can also be used. The RF or microwave oscillation frequency of the COEO can be tuned by tuning the resonant frequency of the micro-resonator by changing an operating condition of the micro-resonator. e.g., applying a voltage on the resonator that exhibits an opto-electro effect to change a refractive index of the resonator, a mechanical force to change a dimension of the resonator, or by changing its temperature. This tuning of the RF frequency can be used to provide the desired frequency sweep such as a linear sweep as shown in FIG. 1.

The COEO can be formed over a substrate such as a semiconductor substrate and can include a semiconductor optical modulator formed on the substrate to modulate an optical beam in response to an electrical modulation signal. The COEO in FIG. 9 includes a first waveguide formed on the substrate having a first end that is to receive a modulated optical signal from the optical modulator, and a second end that has an angled facet coupled to the micro-resonator via evanescent coupling, a second waveguide formed on the substrate and having a first end with an angled facet which is coupled to the microresonator via evanescent coupling, and a semiconductor photodetector formed on the substrate to receive and convert an optical output from the second waveguide into an electrical signal. The optical modulator in FIG. 9 is an electro-absorption optical modulator formed on the substrate. In addition, an electrical link is formed on coupled between the photodetector and the electro-absorption optical modulator to produce the electrical modulation signal from the electrical signal. At least part of the first and second waveguides is doped to produce an optical gain to produce a laser oscillation in a laser cavity formed by the optical waveguides and the microresonator. In this particular example, a high reflector (HR) of a high optical reflectivity (e.g., 98% or above to 100% in some implementations) is formed on the side of the electro-absorption optical modulator as a first optical reflector to form a first optical end of the laser cavity and the other end of the laser cavity is formed with a second optical reflector (or a partial reflector) at the end facet of the corresponding waveguide to allow for some optical transmission of the laser light as the optical output of the device. This second optical reflector is designed to have an optical reflectivity less than 100% to provide a desired amount of optical transmission for producing the laser output while maintaining the sufficient total gain of the laser cavity for sustaining the laser operation. In some implementations, for example, the second optical reflector can be formed by a gap between the photodetector and the end facet of the optical waveguide or an optical reflective structure to induce desired optical reflection back to the waveguide to the microresonator with a desired optical transmission. Accordingly, in this example shown in FIG. 9, the first reflector HR and the second reflector forms a folded Fabry-Perot resonator as the laser cavity with the electro-absorption optical modulator, the two optical waveguides doped with active ions for producing the optical gain and the microresonator as intra-cavity elements inside the laser cavity. This laser cavity can be operated in a mode-locking condition by the optical modulation of the electro-absorption optical modulator to modulate the optical gain inside the laser cavity in response to the detector signal from the photodetector as the electrical modulation signal. This mode locking causes the generation of laser pulses as the laser output and the opto-electronic feedback loop formed by this laser cavity (the optical part), the photodetector (the interface between the optical part and the electrical part) and the circuitry between the photodetector and the electro-absorption optical modulator an RF oscillation represented by the detector signal which can be coupled as an RF output of the device.

The COEO in FIG. 9 for LiDAR or OFDR systems is an integrated COEO that includes a high-Q optical resonator in an electrically controllable feedback loop. An electro-optical modulator is provided to modulate an optical signal in response to at least one electrical control signal. At least one opto-electronic feedback loop, having an optical part and an electrical part, is coupled to the electro-optical modulator to produce the electrical control signal as a positive feedback. The electrical part of the feedback loop converts a portion of the modulated optical signal that is coupled to the optical part of the feedback loop into an electrical signal and feeds at least a portion of it as the electrical control signal to the electro-optical modulator. The high-Q optical resonator may be disposed in the optical part of the opto-electronic feedback loop or in another optical feedback loop coupled to the opto-electronic feedback loop, to provide a sufficiently long energy storage time and hence to produce an oscillation of a narrow linewidth and low phase noise. The mode spacing of the optical resonator is equal to one mode spacing, or a multiplicity of the mode spacing, of the opto-electronic feedback loop. In addition, the oscillating frequency of the OEO is equal to one mode spacing or a multiple of the mode spacing of the optical resonator. The optical resonator may be implemented in a number of configurations, including, e.g., a Fabry-Perot resonator, a fiber ring resonator, and a microsphere resonator operating in whispering-gallery modes. These and other optical resonator configurations can reduce the physical size of the OEO devices and allow integration of an OEO with other photonic devices and components in a compact package such as a single semiconductor chip.

Mode locking in FIG. 9 is achieved by injecting an RF signal at a proper RF frequency equal to the mode spacing or a multiple of mode spacing of the laser cavity formed by the two reflectors on the two ends of the two waveguides to force the phases of the longitudinal modes in the laser cavity to be interdependent and in phase with one another to be locked so that the sidebands of each modulated mode will coincide with its neighboring bands, causing injection-lock of its neighboring bands with itself in phase. This results in a pulsed output of the laser cavity in the time domain. After the mode locking is established, the actual mode spacing of the laser cavity is equal to the frequency of the external RF driving signal.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is what is disclosed or illustrated, including:

1. A light detection and ranging (LiDAR) system, comprising:
an opto-electronic oscillator that includes a laser, an electrically controllable optical modulator connecting to the laser, an opto-electronic feedback loop that comprises an optical part and an electrical part interconnected by a photodetector to receive a modulated optical output from the optical modulator and to convert the modulated optical output into an electrical signal to control the optical modulator so that the modulated optical output is modulated to carry an electrical oscillation signal at a radio frequency (RF) or microwave frequency, wherein the opto-electronic feedback loop is structured to feed the electrical signal in phase to the optical modulator to generate and sustain both optical modulation and electrical oscillation at the radio frequency or microwave frequency, wherein the opto-electronic oscillator is tunable to change the radio frequency or microwave frequency of the electrical oscillation signal;
an optical scanner coupled to receive a portion of the modulated optical output from the optical modulator of the opto-electronic oscillator as probe light for illuminating a target;|

an optical detector located to receive returned probe light from the target to produce a detector electrical signal; and
a signal mixer coupled to the opto-electronic oscillator to receive the electrical signal from the electrical part of the opto-electronic feedback loop of the opto-electronic oscillator and coupled to receive the detector electrical signal from the optical detector, the signal mixer operable to mix the electrical signal and the detector electrical signal to produce beat signals representing position information of the target based on a change in the radio frequency or microwave frequency of the electrical oscillation signal from the opto-electronic oscillator.

2. The LiDAR system as in claim 1, wherein the opto-electronic oscillator is an integrated opto-electronic oscillator and includes:
a substrate on which the laser is formed to produce laser light;
the optical modulator formed on the substrate and optically coupled to receive the laser light from the laser and the electrical signal to cause optical modulation on the received laser light in response to the electrical signal to produce modulated laser light that is present in the optical part of the opto-electronic feedback loop;
optical waveguides formed on the substrate as part of the optical part of the opto-electronic feedback loop, wherein at least one of the optical waveguides is optically coupled to receive the modulated laser light from the optical modulator;
an optical resonator formed on the substrate and optically coupled to the optical waveguides to receive the modulated laser light as part of the optical part of the opto-electronic feedback loop;
the photodetector formed on the substrate and optically coupled to receive the modulated laser light from the optical part of the opto-electronic feedback loop to produce an electrical detector signal; and
a circuit coupled to receive the electrical detector signal from the photodetector and to generate the electrical signal based on the electrical detector signal, the circuit further coupled to the optical modulator to apply the electrical signal to the optical modulator as part of the electrical part of the opto-electronic feedback loop.

3. The LiDAR system as in claim 2, wherein the optical resonator is tunable in its resonant frequency to tune the radio frequency or microwave frequency of the electrical oscillation signal from the opto-electronic oscillator.

4. The LiDAR system as in claim 1, wherein the optical modulator includes an electro-absorption modulator.

5. The LiDAR system as in claim 1, wherein the laser includes a diode laser.

6. The LiDAR system as in claim 1, wherein the laser includes a distributed feedback laser.

7. The LiDAR system as in claim 2, wherein the resonator includes a microsphere resonator coupled to the optical waveguides via evanescent coupling.

8. The LiDAR system as in claim 1, wherein the circuit includes a tunable radio frequency or microwave frequency filter to filter the electrical signal in frequency.

9. The LiDAR system as in claim 1, wherein the circuit includes a tunable radio frequency or microwave frequency phase shifter, a radio frequency or microwave frequency amplifier and a radio frequency or microwave frequency coupler.

10. The LiDAR system as in claim 1, wherein a tunable filter is included in the opto-electronic feedback loop.

11. The LiDAR system as in claim 1, wherein the opto-electronic oscillator includes a laser that is not tunable and produces laser light at a fixed laser frequency.

12. The LiDAR system as in claim 11, wherein the laser that is not tunable and is a fixed frequency laser used in fiber communications.

13. The LiDAR system as in claim 1, wherein the opto-electronic oscillator includes an optical tuning device coupled to the optical part of the opto-electronic feedback loop to tune the radio frequency or microwave frequency of the electrical oscillation signal from the opto-electronic oscillator.

14. The LiDAR system as in claim 13, wherein the optical tuning device includes a fiber stretcher coupled to a fiber line in the optical part of the opto-electronic feedback loop.

15. The LiDAR system as in claim 1, wherein the opto-electronic oscillator includes an electrical tuning device coupled to the electrical part of the opto-electronic feedback loop to tune the radio frequency or microwave frequency of the electrical oscillation signal from the opto-electronic oscillator.

16. The LiDAR system as in claim 15, wherein the electrical tuning device includes a radio frequency or microwave frequency filter.

17. The LiDAR system as in claim 1, wherein an optically dispersive component is included in the opto-electronic loop and the laser is tuned in frequency to tune the radio frequency or microwave frequency of the electrical oscillation signal from the opto-electronic oscillator.

18. A method for detecting objects based on light detection and ranging (LiDAR), comprising:
operating an opto-electronic oscillator to produce modulated optical output that is modulated to carry an electrical radio frequency (RF) or microwave oscillation signal at a radio frequency or microwave frequency for LiDAR sensing;
controlling the opto-electronic oscillator to tune the radio frequency or microwave frequency of the electrical radio frequency (RF) or microwave oscillation signal over time;
scanning the modulated optical output from the opto-electronic oscillator as probe light for illuminating a region of interest to detect objects in the region;|

operating an optical detector to receive returned probe light from the region to produce a detector electrical signal; and
mixing the electrical signal from the opto-electronic feedback loop of the opto-electronic oscillator and the detector electrical signal from the optical detector to produce beat signals representing position information of objects present in the region illuminated by the scanning probe light based on the tuning in the radio frequency or microwave frequency of the electrical oscillation signal from the opto-electronic oscillator.

19. The method as in claim 18, comprising:
tuning the opto-electronic oscillator to change the radio frequency or microwave frequency carried by the modulated optical output in performing LiDAR sensing without using a tunable laser in the opto-electronic oscillator.

20. The method as in claim 18, comprising:
using the beat signals representing position information of objects present in the region illuminated by the scanning probe light to generate a 2-dimensional map of the region containing detected objects.

21. The method as in claim 18, comprising:
using the beat signals representing position information of objects present in the region illuminated by the scanning probe light to generate a 3-dimensional map of the region containing detected objects.

22. A light detection and ranging (LiDAR) system, comprising:
an opto-electronic oscillator that includes (1) a laser cavity that includes an electrically controllable optical modulator to cause mode locking in the laser cavity to produce laser pulses, and (2) an opto-electronic feedback loop that comprises an optical part and an electrical part interconnected by a photodetector to receive a modulated optical output from the optical modulator in the laser cavity and to convert the modulated optical output into an electrical signal to control the optical modulator for mode locking, wherein the opto-electronic feedback loop is structured to feed the electrical signal in phase to the optical modulator to generate and sustain both laser operation in the laser cavity and electrical oscillation at the radio frequency or microwave frequency in the opto-electronic feedback loop;
an optical scanner coupled to receive a portion of the modulated optical output from the optical modulator of the opto-electronic oscillator as probe light for illuminating a target;|

an optical detector located to receive returned probe light from the target to produce a detector electrical signal; and
a processing circuit coupled to receive the electrical signal from the electrical part of the opto-electronic feedback loop of the opto-electronic oscillator and coupled to receive the detector electrical signal from the optical detector and to process the received signals to determine position information of the target based on time delays in receiving the laser pulses in the returned probe light.

23. The LiDAR system as in claim 22, wherein the laser cavity includes:
a substrate on which the optical resonator is formed;
optical waveguides formed on the substrate as part of the optical part of the opto-electronic feedback loop and optically coupled to the optical resonator, wherein at least one of the optical waveguides is doped to produce an optical gain;
an electro-absorption modulator formed on the substrate as part of the optical modulator and part of the optical part of the opto-electronic feedback loop and coupled to receive the electrical signal to cause optical modulation on light inside the optical part of the opto-electronic feedback loop in response to the electrical signal to produce modulated light;
optical reflectors formed in the optical part the opto-electronic feedback loop and configured to be at least partially optical reflective to reflect light back and forth in the optical part to form an optical resonator to amplify the light based on the optical gain in at least one of the optical waveguides;
an optical resonator formed on the substrate and optically coupled to the optical waveguides to receive the modulated light as part of the optical part of the opto-electronic feedback loop;
the photodetector formed on the substrate and optically coupled to receive the modulated light from the optical part of the opto-electronic feedback loop to produce an electrical detector signal; and
wherein the electrical part of the opto-electronic feedback loop includes a circuit coupled to receive the electrical detector signal from the photodetector and to generate the electrical signal based on the electrical detector signal, the circuit further coupled to the electro-absorption modulator to apply the electrical signal to the electro-absorption modulator as part of the electrical part of the opto-electronic feedback loop.

24. The LiDAR system as in claim 23, wherein the photodetector is formed by a second electro-absorption modulator that is reverse biased to function as an optical detector.

25. The LiDAR system as in claim 23, wherein the optical resonator in the laser cavity includes a microresonator that is optically evanescently coupled in the laser cavity.

26. The LiDAR system as in claim 25, wherein the microresonator is a sphere resonator.

27. A method for detecting objects based on light detection and ranging (LiDAR), comprising:
operating an opto-electronic oscillator to produce modulated optical output that is modulated by an optical modulator to carry an electrical radio frequency (RF) or microwave oscillation signal at a radio frequency or microwave frequency for LiDAR sensing;
operating a laser cavity, which includes one or more optical gain media inside the laser cavity and the optical modulator inside the laser cavity, to modulate light inside the laser cavity to achieve mode locking to produce laser pulses;
scanning the modulated optical output from the opto-electronic oscillator as probe light for illuminating a region of interest to detect objects in the region;|

operating an optical detector to receive returned probe light from the region to produce a detector electrical signal; and
processing the electrical signal from the opto-electronic oscillator and the detector electrical signal from the optical detector to determine relative delays of the laser pulses in the returned probe light from the region to determine the positions of the objects present in the region.

28. An optical frequency domain reflectometer (OFDAR) system, comprising:
an opto-electronic oscillator that includes a laser, an electrically controllable optical modulator connecting to the laser, an opto-electronic feedback loop that comprises an optical part and an electrical part interconnected by a photodetector to receive a modulated optical output from the optical modulator and to convert the modulated optical output into an electrical signal to control the optical modulator so that the modulated optical output is modulated to carry an electrical oscillation signal at a radio frequency (RF) or microwave frequency, wherein the opto-electronic feedback loop is structured to feed the electrical signal in phase to the optical modulator to generate and sustain both optical modulation and electrical oscillation at the radio frequency or microwave frequency, wherein the opto-electronic oscillator is tunable to change the radio frequency or microwave frequency of the electrical oscillation signal;
a length of optical fiber coupled to receive a portion of the modulated optical output from the optical modulator of the opto-electronic oscillator as probe light;|

an optical detector located to receive returned probe light from the fiber to produce a detector electrical signal; and
a signal mixer coupled to the opto-electronic oscillator to receive the electrical signal from the electrical part of the opto-electronic feedback loop of the opto-electronic oscillator and coupled to receive the detector electrical signal from the optical detector, the signal mixer operable to mix the electrical signal and the detector electrical signal to produce beat signals representing position information of reflections inside the optical fiber based on a change in the radio frequency or microwave frequency of the electrical oscillation signal from the opto-electronic oscillator.

29. A method for detecting reflections in an optical fiber based on optical frequency domain reflectometer (OFDR), comprising:
operating an opto-electronic oscillator to produce modulated optical output that is modulated to carry an electrical radio frequency (RF) or microwave oscillation signal at a radio frequency or microwave frequency for OFDR sensing;
controlling the opto-electronic oscillator to tune the radio frequency or microwave frequency of the electrical radio frequency (RF) or microwave oscillation signal over time;
scanning the modulated optical output from the opto-electronic oscillator as probe light inside the optical fiber;|

operating an optical detector to receive returned probe light from the region to produce a detector electrical signal; and
mixing the electrical signal from the opto-electronic feedback loop of the opto-electronic oscillator and the detector electrical signal from the optical detector to produce beat signals representing position information of reflections inside the optical fiber based on the tuning in the radio frequency or microwave frequency of the electrical oscillation signal from the opto-electronic oscillator.
